(19) United States
(12) Patent Application Publication
(10) Pub. No.: US 2020/0226834 A1
(43) Pub. Date: Jul. 16, 2020

(54) METHOD AND SYSTEM FOR TRACKING DATA OF A VR, AR OR MR DEVICE WEARER IN REAL TIME

(71) Applicant: CONVERGE DIRECT LLC, NEW YORK, NY (US)

(72) Inventor: PAUL D. LeFEVRE, VALLEY CENTER, CA (US)

(73) Assignee: CONVERGE DIRECT LLC, NEW YORK, NY (US)

(21) Appl. No.: 16/263,934

(22) Filed: Jan. 31, 2019

Related U.S. Application Data
(60) Provisional application No. 62/792,673, filed on Jan. 15, 2019.

(51) Int. Cl. G06T 19/00; G06F 1/16; G06F 3/01

(52) U.S. Cl. CPC G06T 19/006; G06F 3/012; G06F 3/013; G06F 1/163

(57) ABSTRACT

In a method adapted to track and analyze spatial analytics data of any of a VR, AR, or MR device wearer within their digital reality environment, x, y, and z coordinate data is gathered in real time while the wearer operates in their digital reality environment. The spatial analytics data is then packaged and transformed for display to in near real time to a developer of the environment for analysis thereby.

### CROSS-REFERENCE TO RELATED APPLICATION

The present application claims the benefit under 35 U.S.C. § 119(e) to co-pending and commonly-assigned U.S. Provisional Patent Application Ser. No. 62/792,673 to Jacobson, et al., filed Jan. 15 2019, the entire contents of which is hereby incorporated by reference herein.

### BACKGROUND

### Field

Example embodiments in general relate to a computer-implemented method and system for tracking real time data of any of a virtual reality (VR), augmented reality (AR) or mixed reality (MR) device wearer within as the wearer operates in their digital reality environment so as to generate spatial analytics information of the wearer for analysis in near real time.

### Related Art

Virtual Reality (VR) and Augmented Reality (AR) are two of the most widely discussed concepts in today's technology circles. Virtual reality headsets have the potential to make a significant change in the way consumers work, experience entertainment, make purchases and participate in social activities. With applications and opportunities in the 3D/4D technology market, VR and AR are expected to be far-reaching technologies in the next 10 years.

Virtual reality (VR) is an artificial, computer-generated simulation or recreation of a real life environment or situation. It immerses the user by making them feel like they are experiencing the simulated reality firsthand, primarily by stimulating their vision and hearing. While there, the user is also able to operate objects or perform a series of activities. Virtual reality can recreate sensory experiences, which include virtual sight, sound, and touch.

VR is typically achieved by wearing a headset like OCULUS® from FACEBOOK® that is equipped with the technology, and is used prominently in two different ways: (a) to create and enhance an imaginary reality for gaming, entertainment, and play (such as video and computer games, or 3D movies, head mounted display); and (b) to enhance training for real life environments by creating a simulation of reality where people can practice beforehand (Such as flight simulators for pilots). Virtual reality in its earlier stages was possible through a coding language known as VRML (Virtual Reality Modeling Language) in order to create a series of images and specify what types of interactions are possible for them. Today, the UNITY® engine is used in VR and AR applications. The UNITY engine was developed by UNITY and released in June 2005 at APPLE®'s Worldwide Developers Conference as an OS X-exclusive game engine. As of 2018, the engine has been extended to support 27 platforms. UNITY VR lets the developer target virtual reality devices directly from UNITY, without any external plug-ins in projects. It provides a base API and feature set with compatibility for multiple devices. It has been designed to provide forward compatibility for future devices and software.

Augmented reality (AR) is a technology that layers computer-generated enhancements atop an existing reality in order to make it more meaningful through the ability to interact with it. AR is developed into apps and used on mobile devices and/or mobile platforms to blend digital components into the real world in such a way that they enhance one another, but can also be torn apart easily. AR technology is quickly coming into the mainstream. It is used to display score overlays on telecasted sports games and pop out 3D emails, photos or text messages on mobile devices. Leaders of the tech industry are also using AR to do revolutionary things with holograms and motion activated commands.

AR and VR are inverse reflections of one in another with what each technology seeks to accomplish and deliver for the user. Virtual reality offers a digital recreation of a real life setting, while augmented reality delivers virtual elements as an overlay to the real world.

The virtuality continuum is a continuous scale ranging between the completely virtual, a “virtuality”, and the completely real, or “reality”. Milgram's reality—virtuality continuum, as shown in FIG. 1 and first introduced by Paul Milgram in 1994, therefore encompasses all possible variations and compositions of real and virtual objects. Referring to FIG. 1, the area between the two extremes, where both the real and the virtual are mixed, is called mixed reality, or MR. This in turn is said to consist of both augmented reality, where the virtual augments the real, and augmented virtuality, where the real augments the virtual. AR and MR are now sometimes used as synonyms, and are typically grouped together for purposes of global revenue projections.

Augmented and virtual realities both leverage some of the same types of technology, and each exist to serve the user with an enhanced or enriched experience. For example, within the entertainment sector, both technologies enable experiences that are becoming more commonly expected and sought after for entertainment purposes. While in the past they seemed merely a figment of a science fiction imagination, new artificial worlds come to life under the user's control, and deeper layers of interaction with the real world are also achievable. Leading tech moguls are investing and developing new adaptations, improvements, and releasing more and more products and apps that support these technologies for the increasingly savvy users.

Within the science and medical sectors, both VR and AR have great potential in changing the landscape of the medical field by making things such as remote surgeries a real possibility. These technologies are now being used to treat and heal psychological conditions such as Post Traumatic Stress Disorder (PTSD).

The purpose of augmented reality and/or mixed reality is therefore to enhance the user's experiences by adding virtual components such as digital images, graphics, or sensations as a new layer of interaction with the real world. In contrast, virtual reality creates its own reality that is completely computer-generated and driven. Additionally, where VR is primarily delivered to the user through a head-mounted, or hand-held controller, AR and MR are being used more and more in mobile devices such as laptops, smart phones, and tablets to change how the real world, digital images, and graphics intersect and interact.

However, VR and AR do not always operate independently; in fact VR and AR are often blended together to generate an even more immersing experience. For example, haptic feedback (which is the vibration and sensation added to interaction with graphics), is considered an augmentation. However, haptic feedback is commonly used within a virtual reality setting in order to make the experience more lifelike though touch. Accordingly, VR and AR are fueled by the user's desire to become immersed in a simulated land for entertainment and play, or to add a new dimension of interaction between digital devices and the real world. Alone or blended together, they are now opening up worlds, real and virtual alike.

FIG. 2 illustrate side by side graphs of actual and projected consumer virtual reality (VR) revenue and projected augmented reality/mixed reality (AR/MR) revenue between the years 2016 to 2021. Augmented and mixed reality global revenue is projected to more than double to $3.2 billion in 2018, and that revenue is expected to exceed VR revenue by 2021. As shown in FIG. 2 and according to the latest 2018 report from market intelligence firm SUPERDATA®, consumer VR revenue will reach $4.5 billion in 2018, and $19 billion by 2021.

Consumer AR/MR revenue meanwhile is expected to grow slightly slower, eventually surpassing VR with the increased access to smartphone software and high-end devices like the head-mounted virtual retinal display MAGIC LEAP®, which superimposes 3D computer-generated imagery over real world objects by projecting a digital light field into the user's eye, and like the MICROSOFT® HOLOLENS®, touted as the first self-contained, holographic computer, enabling the wearer to engage with their digital content and interact with holograms in the world around them. Mobile AR is predicted to be the primary driver of revenue for the next three years (2019-2021), earning twice as much as AR and MR headsets, which could remain prohibitively expensive for general consumer audiences for some time.

A burgeoning area in the VR/AR/MR landscape is the application of these technologies to analytics, and more specifically to spatial analysis. Spatial analysis is a set of techniques for analyzing spatial data. The results of spatial analysis are dependent on the locations of the objects being analyzed. Software that implements spatial analysis techniques require access to both the locations of objects and their attributes.

One new and growing application for spatial analysis in combination with VR and AR technologies is in the GIS space. Known as the geographic information system, GIS is a system designed to capture, store, manipulate, analyze, manage, and present all types of geographical data. In the simplest terms, GIS is the merging of cartography, statistical analysis, and database technology. As AR is now connecting a world of data for people who may not be familiar with GIS, the combination of 3D, AR and VR spaces appear to provide a growing solution in this industry.

Recall the game POKEMON®, a NINTENDO® game on a cell phone. POKEMON helped introduce to millions the concept of merging real-life maps and information with things that don't exist in a human's real space. AR is now opening up the entire field of GIS to people unfamiliar with such geography or mapping.

Various projects are being addressed using 3D technology and VR/AR to work on predicting, developing and implementing innovations for tomorrow's cities, such as the generation of 3D urban models as key planning tools for towns and cities, which can be used in conjunction with AR and VR to make the planning process more transparent. Simulations of the spread of noise/pollutants or of areas exposed to the sun or in the shade help workable, sustainable decisions to be reached, and opens up the innovative involvement of city dwellers while creating a real-time experience. Other aspects of GIS with VR/AR include assisting oil workers laying pipe in a remote location where they may not know where the exact coordinate is, but with this combined technology could draw a red ‘X’ on the spot where the pipe should go, or shade an area in red that is dangerous for them to go into, or to identify land in that area which is owned by another so as to avoid laying pipe in that area. These are just a few of the applications where spatial analytics receiving VR and AR inputs may be used to better mankind.

In an entire other vertical, some startup companies have now surfaced in an effort to help customers (such as retailers, marketers, and the like) understand their users better within VR and AR digital experiences. Namely, they employ what they term as spatial analytics, whereby an analytics platform developed by the company receives inputs from humans who are connecting with digital realities in the VR, AR and/or MR spaces. One of these companies CognitiveVR, Inc. out of Vancouver, British Columbia, now re-branded as Cognitive3D. This company submits that their spatial analytics solutions reveal new behavioral metrics crafted for virtual, augmented, and mixed reality, and claim to have built platforms which record, measure, aggregate, and analyze digital data from VR, AR and MR user experiences to generate a report to their clients with actionable insights, such as insights which aid brands in developing better products, understanding spaces in new ways, and/or carrying out training with clearer results.

In general, and in the context of describing the SceneExplorer product by Cogntive3D, the product works by exporting a user's VR headset scenes to the web, and then automatically pushes user session data as the user VR experience is in process. The software development kit (SDK) is then dropped into UNITY®, which is the most widely used VR development platform, with over 91% of all HOLOLENS experiences being made with UNITY. Once in the UNITY VR engine, the VR designer selects “Export Scene” in order to locally store the user session data, and then enables the player tracker script for the user. For the customer, the client, or the VR designer, SceneExplorer provides a comprehensive look at what VR headset users are doing, seeing, and where they are going in their VR environment.

DISNEY® Research has been working on a data analytics process they call “Factorized Variational Auto-encoders for Modeling Audience Reactions to a Movie”. In this process, Disney Research has looked at non-linear tensor factorization methods based on deep variational auto-encoders. Their approach is used in settings where the relationship between the latent representation to be learned and the raw data representation is highly complex. As shown by the images in FIG. 3, they have applied their process to a large dataset of facial expressions of movie-watching audiences (over 16 million faces). In the Disney Research process, they store the actual facial expressions of the moviegoers as they are experience a digital experience (movie) and then process the stored data for later analysis. Their early experiments show that compared to conventional linear factorization methods, their method achieves better reconstruction of the data, and further discovers interpretable latent factors.

However, Cognitive3D and Disney Research simply collect data on a human's experiences within the digital reality environment, and then store the analytical data for later processing. The developer eventually receives the analytics, usually weeks later. There is no real time application available today to collect a human being's data as they operate within the digital reality environment. What is needed is a system and method that can collect analytical data “on the run” as the human is experiencing their digital reality environment.

### SUMMARY

An example embodiment of the present invention is directed to a computer-implemented method implemented by processing power of a computing device to track and analyze spatial analytics data of any of a virtual reality (VR), augmented reality (AR) or mixed reality (MR) device wearer as the wearer operates within their digital reality environment. The method includes gathering raw spatial analytics data of the wearer in real time as the wearer is experiencing their digital reality environment, packaging and transforming the real time gathered raw spatial analytics data into intelligible data formats, and then immediately displaying, for analysis by a developer, the transformed spatial analytics data in near real time.

Another example embodiment is directed to a computer system adapted to track and analyze spatial analytics data of any of a virtual reality (VR), augmented reality (AR) or mixed reality (MR) device wearer as the wearer operates within their digital reality environment. The system includes a processing hardware set, and a computer-readable storage device medium, wherein the processing hardware set is structured, connected and/or programmed to run program instructions stored on the computer-readable storage medium instructions and associated data. The program instructions include a tracking module programmed to gather raw spatial analytics data of the wearer in real time as the wearer is experiencing their digital reality environment and to transform the raw data into intelligible data formats. The program instructions include a database module programmed to receive the spatial analytics data gathered by the tracking module and to package the data for network transmission to a support database for permanent storage. The program instructions further include a real time user interface module programmed to, upon receiving the transformed real time spatial analytics data of the wearer from the tracking module, immediately enable a developer of the wearer's environment to graphically review and analyze the transformed spatial analytics data in near real time.

Another example embodiment is directed to a computer system having therein a set of machine-readable instructions and associated data, stored on a storage device of the system in a manner more persistent than a signal in transit, the set of instructions and associated data enabling the system to track real time data of any of a virtual reality (VR), augmented reality (AR) or mixed reality (MR) device wearer as the wearer operates in their digital reality environment, so as to generate spatial analytics information of the wearer for display and analysis. The system includes a tracking module programmed in accordance with the set of machine-readable instructions and associated data to gather raw spatial analytics data of the wearer in real time as the wearer operates in their environment, and a real time user interface module programmed in accordance with the set of machine-readable instructions and associated data to, enable a developer of the system to see graphically in near real time spatially where the wearer is in within the wearer's digital reality environment, to see spatially where the wearer spends time or does not spend time within their digital reality environment, and to see spatially which objects the headset wearer views or interacts within their digital reality environment.

In a computer system adapted to track and collect, in real time, raw spatial analytics data of any of a virtual reality (VR), augmented reality (AR) or mixed reality (MR) device wearer as the wearer operates in their digital reality environment, so as to generate transformed spatial analytics information on the wearer for display and analysis by a developer using the system, a further example embodiment is directed to a real time user interface module of the system. The module includes means to enable the developer to see graphically in near real time: (i) spatially where the wearer is in within the wearer's digital reality environment, (ii) spatially where the wearer spends time or does not spend time within their digital reality environment, and (iii) spatially which objects the wearer views or interacts within their digital reality environment. The near real time represents 10 seconds or less after the raw spatial analytics data is collected in real time by the computer system.

### BRIEF DESCRIPTION OF THE DRAWINGS

Example embodiments will become more fully understood from the detailed description given herein below and the accompanying drawing, wherein like elements are represented by like reference numerals, which are given by way of illustration only and thus are not limitative of the example embodiments herein.

FIG. 1 is a graph of Milgram's reality—virtuality continuum.

FIG. 2 illustrate side by side graphs of actual and projected consumer virtual reality (VR) revenue and projected augmented reality/mixed reality (AR/MR) revenue between the years 2016 to 2021.

FIG. 3 is an illustration describing a process by which facial expressions of moviegoers are recorded as they watch a movie.

FIG. 4 is a system block diagram of a computer-based spatial analytics system according to the example embodiments.

FIG. 5 is a flow diagram to illustrate a method for tracking and analyzing spatial analytics data of any of a virtual reality (VR), augmented reality (AR) or mixed reality (MR) wearer within their digital reality environment, according to the example embodiments.

FIG. 6 is a screenshot example of the RTUI module showing the graphical feedback of captured spatial analytics data of the wearer according to the example embodiments.

FIG. 7 is a screenshot example of the analytics front end module showing graphical display outputs from the spatial analytics data.

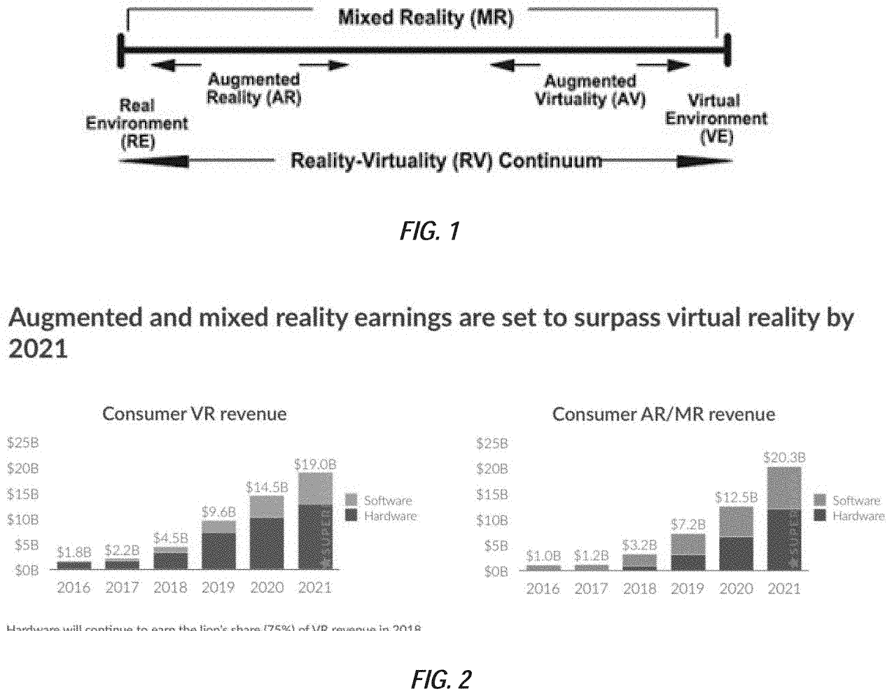

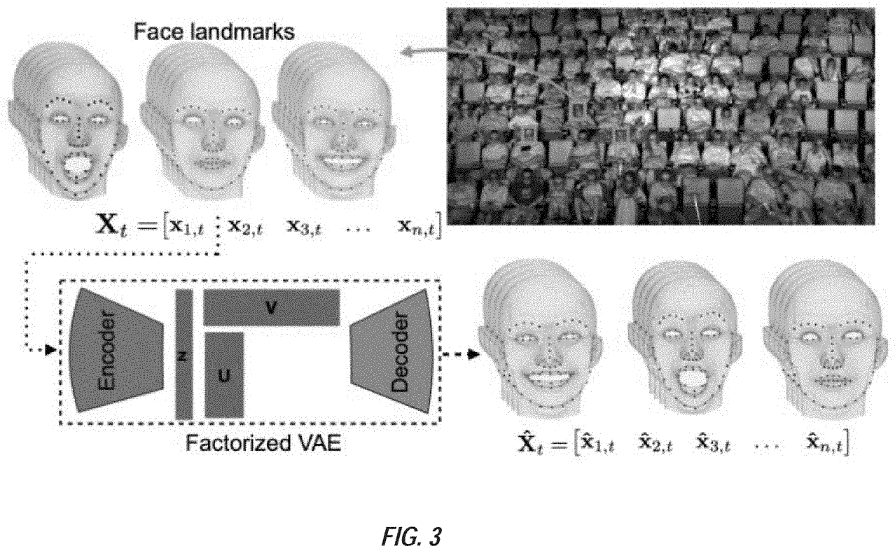

### DETAILED DESCRIPTION

In general, and as to be more fully described hereafter the inventors have devised a computer-implemented method (and computer system to implement steps of the method) for tracking and analyzing spatial analytics data of any of a virtual reality (VR), augmented reality (AR) or mixed reality (MR) device wearer within their digital reality environment. As to be described in further detail below, the example system employs, among other modules, a real-time user interface (“RTUI”) module and a tracking module in communication therewith and operatively connected thereto. The tracking module tracks and gathers spatial analytics data in real time as the wearer is experiencing their digital reality environment, and the RTUI module provides a near real-time graphical display of the gathered real time spatial analytics data that permits a designer (i) to see where the wearers are within the digital reality space within their VR/AR/MR application, (ii) see where the wearers spend time (or don't spend time) in the virtual world, and (iii) to see which objects the wearers view or interact with within their digital reality environment. As further described, and for each displayed graphics frame, the tracking module gathers 3D spatial data (x, y, z coordinates) on the above. The tracking module then packages, transforms, and stores the data locally (on-device) and communicates with the RTUI Module to provide the designer a real time display of the spatial analytical data.

As used herein, the phrase “digital reality environment”, occasionally also referred to herein as a synonymous “digital reality space” and/or “virtual world” means any of a virtual reality (VR), augmented reality (AR), or mixed reality (MR) digital space a human being is experiencing while within the environment, either via the use of a headset, eyewear/glasses/holographic lens, and/or by mobile platforms/mobile technology means. As used herein, the term “XR” (extended reality) is an umbrella term which encompasses virtual reality (VR), augmented reality (AR), and Mixed Reality (MR) applications, technologies, and environments. Namely, extended reality (XR or “cross reality”) refers to all real-and-virtual combined environments and human-machine interactions generated by computer technology and wearables.

As used herein, the generic term “wearer” or “XR device wearer” represents a human being with a wearable XR device attached to the head or body thereof in order to experience an XR developer's application within the digital reality environment, either via the use of a headset, eyewear/glasses/holographic lens, and/or via mobile platforms.

As used herein, the term “developer” (or as the synonymous “user” and/or “XR developer” as occasionally referred to herein) means any of a XR developer of a product or application for use by humans in the digital reality environment. As used herein, the phrase “near real time” in the context of spatial analytics for digital reality environments according to the example embodiments, means the generation of a display or otherwise graphical information for analysis by the XR developer of a human's actions in the digital reality environment within 10 seconds or less from the time the information of the human within the environment is gathered in real time and processed for display and analysis by the developer.

As appreciated by one skilled in the art, the example embodiments of the present invention may be embodied as a computing system, computing device, computer-implemented method, set of machine-readable instructions and associated data in a manner more persistent than a signal in transit, non-transitory computer-readable media, and/or as a computer program product or downloadable mobile app product for a mobile device. Accordingly, aspects of the example embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the example embodiments may take the form of a computer program product embodied in one or more computer-readable medium(s) having computer-readable program code/instructions embodied thereon.

As used herein, the phrase “present invention” should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed as maybe being new; this understanding, as indicated by use of the term “present invention,” is tentative and provisional and subject to change over the course of patent prosecution as relevant information is developed and as the claims are potentially amended. Additionally, and unless the context requires otherwise, throughout the specification and claims that follow, the word “comprise” and variations thereof, such as “comprises” and “comprising,” are to be construed in an open, inclusive sense, that is, as “including, but not limited to.”

As used herein, the terms “program” or “software” are employed in a generic sense to refer to any type of computer code or set of computer-executable instructions that can be employed to program a computer or other processor to implement various aspects of the present invention as discussed above. Additionally, it should be appreciated that one or more computer programs that when executed perform methods of the example embodiments need not reside on a single computer or processor, but may be distributed in a modular fashion amongst a number of different computers or processors to implement various aspects of the example embodiments.

Computer-executable instructions may be in many forms, such as program modules or simply “modules”, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish a relationship between data elements.

The computer system(s), device(s) or module(s), method(s), computer program product(s) and the like, as described in the following example embodiments, may be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means or the like. In general, any device(s) or means capable of implementing the methodology illustrated herein can be used to implement the various aspects of the example embodiments.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus or device, or any suitable combination of the foregoing. A non-exhaustive list of specific examples for a computer-readable storage medium would include at least the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

In the context of this Detailed Description, a computer-readable storage medium may be any tangible medium that can contain or store a program for use by or in connection with an instruction execution system, apparatus or device. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Accordingly, the example embodiments foresee a non-transitory computer-readable information storage media having stored thereon information, that, when executed by a processor, causes the steps described in more detail hereafter in the example method(s) to be performed.

Additionally in the context of this Detailed Description, a computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including but not limited to wireless, wireline, optical fiber cable, RF, etc., or any suitable combination of the foregoing.

The techniques described in the following example embodiments may also be implemented in a distributed computing system that includes a back-end component, e.g., as a data server, and/or a middleware component, e.g., an application server or proxy web server, and/or a front-end component, e.g., a client computer having a graphical user interface and/or a Web browser through which a user can interact with an implementation of the example embodiments of the present invention, or any combination of such back-end, middleware, or front-end components. The components of the system can be interconnected by any form or medium of digital data communication, e.g., a communication network such as a local area network (“LAN”) and a wide area network (“WAN”), e.g., the Internet, and include both wired and wireless networks.

Computer program code for carrying out operations for aspects or embodiments of the present invention may be written in any combination of one or more programming languages, including a programming language such as JAVASCRIPT®, JAVA®, SQLT™, PHP™, RUBY™, PYTHON®, JSON, HTML5™, OBJECTIVE-C®, SWIFT™, XCODE®, SMALLTALK™, C++ or the like, conventional procedural programming languages, such as the “C” programming language or similar programming languages, any other markup language, any other scripting language, such as VBScript, and many other programming languages as are well known may be used.

Reference throughout this specification to “one example embodiment” or “an embodiment” means that a particular feature, structure or characteristic described in connection with the embodiment is included in at least one embodiment. Thus, the appearances of the phrases “in one example embodiment” or “in an embodiment” in various places throughout this specification are not necessarily all referring to the same embodiment. Further, the particular features, structures or characteristics may be combined in any suitable manner in one or more example embodiments.

As used in this specification and the appended claims, the singular forms “a,” “an,” and “the” include plural referents unless the content clearly dictates otherwise. The term “or” is generally employed in its sense including “and/or” unless the content clearly dictates otherwise. As used in the specification and appended claims, the terms “correspond,” “corresponds,” and “corresponding” are intended to describe a ratio of or a similarity between referenced objects. The use of “correspond” or one of its forms should not be construed to mean the exact shape or size. Further, and in the drawings, identical reference numbers identify similar elements or acts. The size and relative positions of elements in the drawings are not necessarily drawn to scale.

As to be set forth more fully below, an example embodiment of the present invention in one example is directed to a computer-implemented method having one or more steps adapted to track data in real time within any of a virtual reality (VR), augmented reality (AR) or mixed reality (MR) space being experienced by the wearer to generate real time spatial analytics information of the wearer for analysis and display in near real time to an XR developer/user of the system and/or method, and to a computer system for implementing the method. In another example, a non-transitory, computer-readable information storage media having stored thereon information is envisioned. When executed by a processor, this stored information causes to be performed the steps of the method. In another example, the inventors envision a set of machine-readable instructions and associated data, stored on a storage device in a manner more persistent than a signal in transit, the set of instructions and data comprising various modules programed to perform the steps of the method.

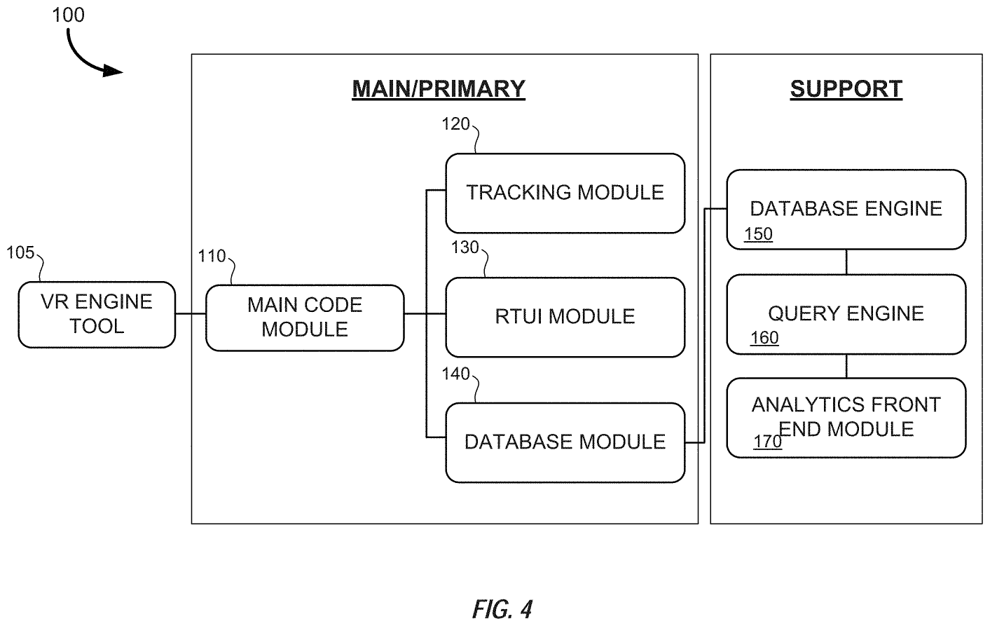

FIG. 4 is a system block diagram of a computer-based spatial analytics system adapted to track real time data of a XR device wearer within their digital reality environment so as to generate spatial analytics information of the wearer. The example spatial analytics system (“system 100”) consists of four primary modules: a main control module 110, a real-time user interface (RTUI) module 120, a tracking module 130, and a database module 140. System 100 also interfaces to several additional support modules including a database engine 150, a query engine 160, and an analytics front end or presentation layer 170. System 100 utilizes and is connected to system/engine features of existing 3D/VR (or 3D with AR/MR) design and runtime engine tools produced by other companies (shown in FIG. 4 as a VR Engine/Tool module 105).

The main control module 110 hooks into the VR Engine/Tool module 105, hooks into drivers of the wearer's device (for example a headset), provides a UI for developer-settable options, and manages the installation, start-up, and run-time of the other operational modules 120, 130, and 140. System 100 in an example can support design/engine tools from UNITY and UNREAL ENGINE®, and run-time environments on PC, MAC®, APPLE® IOS®, as well as ATARI®, UBISOFT®, HTC®, and ANDROID® platforms. Planned additional run-time environments include but are not limited to SONY® PS4® VR and XBOX® VR platforms. For example, the described method and system herein may be applicable to incorporation into or interconnected with AR applications or platforms developed by companies such as VALUECODERS®, INTELLECTSOFT®, XENIUM DIGITAL®, METAGRAM®, VIRTUALWARE® and the like, and to budding MR platforms and applications currently in development or already commercialized by one or more of FACEBOOK, MICROSOFT, GOOGLE, SAMSUNG®, SONY®, NINTENDO®, HUAWEI®, APPLE and others. For each of these platforms, use by a developer of the example method and system as described herein may provide metrics and information to enable the developer to improve, refine and/or enhance their company's product offering, platforms, and/or applications based on better, more accurate wearer data from a human interacting within their virtual world.

The RTUI module 120 provides a near real-time graphical display of spatial analytics data from a wearer gathered in real time using design/engine tools. For example, the RTUI module 120 provides graphical feedback of real time tracking operations, heat maps, and a UI for developers to set options for tracking and the like. This near real-time display allows the developer to see spatially where the wearer is within the digital reality space of their application, to see spatially where the wearer spends time (or does not spend time) in the digital reality world, and to see spatially which objects the wearer views or interacts with, for fine-tuning of application design “on the run” or in real-time.

The tracking module 130 interfaces with the VR Engine/Tool module 105. Every displayed graphics frame, tracking module 130 gathers 3D (x, y, z coordinates) data on the wearer's location in both the world-space and the digital reality space, on the wearer's device (such as headset, eyewear) orientation, the wearer's view direction (a 3D vector indicating where the wearer is “looking”), and any objects that are in the wearer's “look” path. The tracking module 130 then packages, transforms (into 3D world space coordinate data that is understood, namely into multiple coordinate systems and data formats for easier or more complete analysis, known as “ETL” in the industry), and communicates the transformed coordinate data by loading it into both the database module 140 and RTUI module 120 for near real time review and analysis by the developer.

The database module 140 receives the data gathered and transformed into 3D coordinates by the tracking module 130, and packages it for network transmission to the database 150 for permanent storage. The database module 140 detects whether an application is “on-line” (i.e., the wearer is connected to a live network), in which case packaged data is sent intermittently as a stream to database 150, or “off-line”, in which case the data is stored locally in module 140, to be transmitted when the wearer's device has network availability again. The database module 140 additionally manages network traffic and flow across system 100.

The three support modules 150, 160 and 170 are adapted to receive, process, query, and produce visualizations from the spatial analytics data collected by system 100. Database engine 150 may be embodied in an example as a HELIX® database engine. Database engine 150 may be arranged as one or more AWS-based, scalable web servers that implement a network gateway that receives the transmitted spatial analytics data, processes this spatial data, and stores the processed spatial analytical data in data tables for example.

Query engine 160 may be embodied in an example as a HELIX query engine. Query engine 160 may be arranged as one or more AWS-based, scalable web servers that provide a REST interface to the database engine 150, using a proprietary JSON-based query engine, for example. The analytics front end or presentation layer 170 may be a HELIX analytics front end adapted to produce visualizations of the collected real time spatial analytics data that match the near real-time displays available in the design/engine tool, as well as numerous other ways to visualize/analyze the gathered real time spatial analytics data. In an example, front end 170 is embodied as an HTML-5 based SASS application providing a full UI for accessing database engine 150 data, producing custom queries via query engine 160 into the database engine 150, and producing reports including a variety of text and graphic visualizations of the queried data.

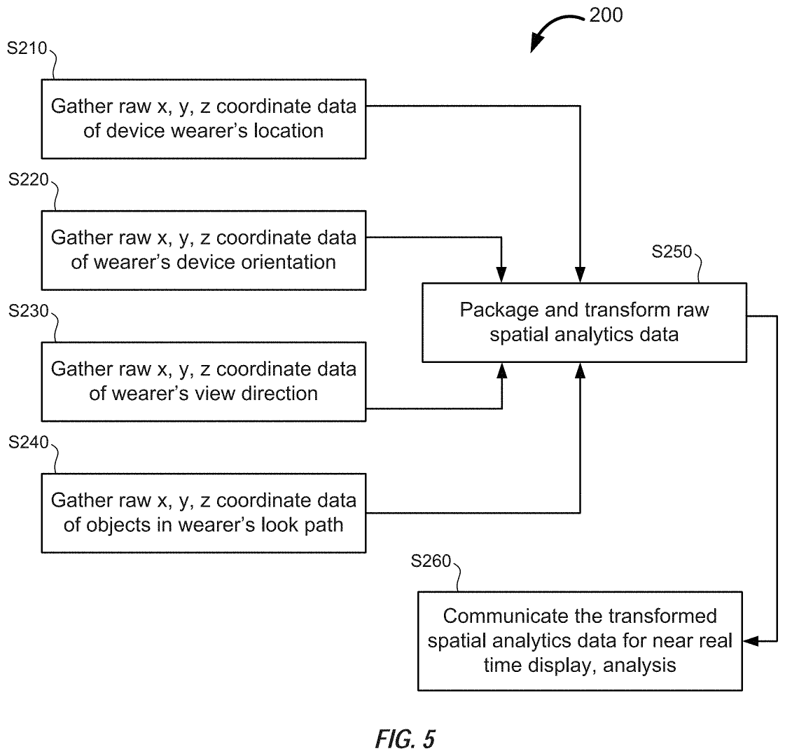

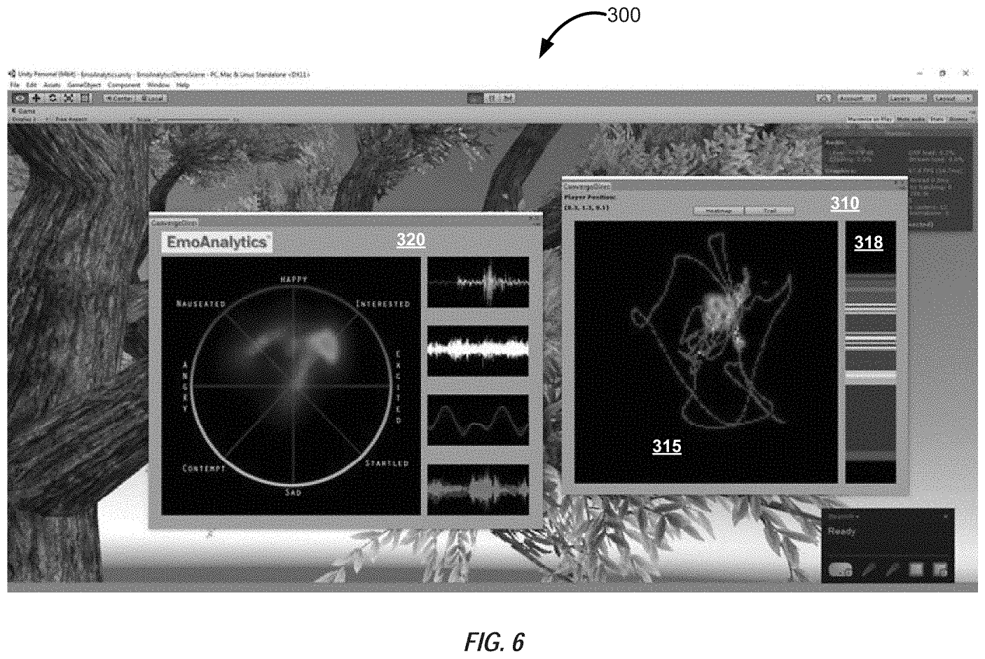

FIG. 5 is a flow diagram to illustrate a method for tracking and analyzing spatial analytics data of any of a virtual reality (VR), augmented reality (AR) or mixed reality (MR) device wearer within their digital reality environment, according to the example embodiments. Referring to FIG. 4, method 200 includes a process whereby the tracking module performs four (4) functions, namely (i) gathering x, y, and z coordinate data on the device wearer's location (step S210) (in both the world-space and VR/AR/MR-room-space), (ii) gathering x, y, and z coordinate data on the wearer's device orientation (step S220), (iii) gathering x, y, and z coordinate data on the wearer's view direction (step S230) (which is a 3D vector indicating where the wearer is “looking”), and (iv) gathering x, y, and z coordinate data of any objects (step S240) that are in the wearer's “look” path. The tracking module 130 then packages, transforms, and stores the collected packaged and transformed spatial analytics data of the device wearer locally (on-device) (step S250). In other words, the real time raw data gathered within the virtual world as the wearer experiences it is transformed into 3D world space coordinates that are understandable, known in the industry as “ETL” (Extract, Transform, and Load). The packaged and transformed spatial analytics data is then communicated (step S260) to the database module 140 and RTUI module 120 for display to and analysis by the XR developer.

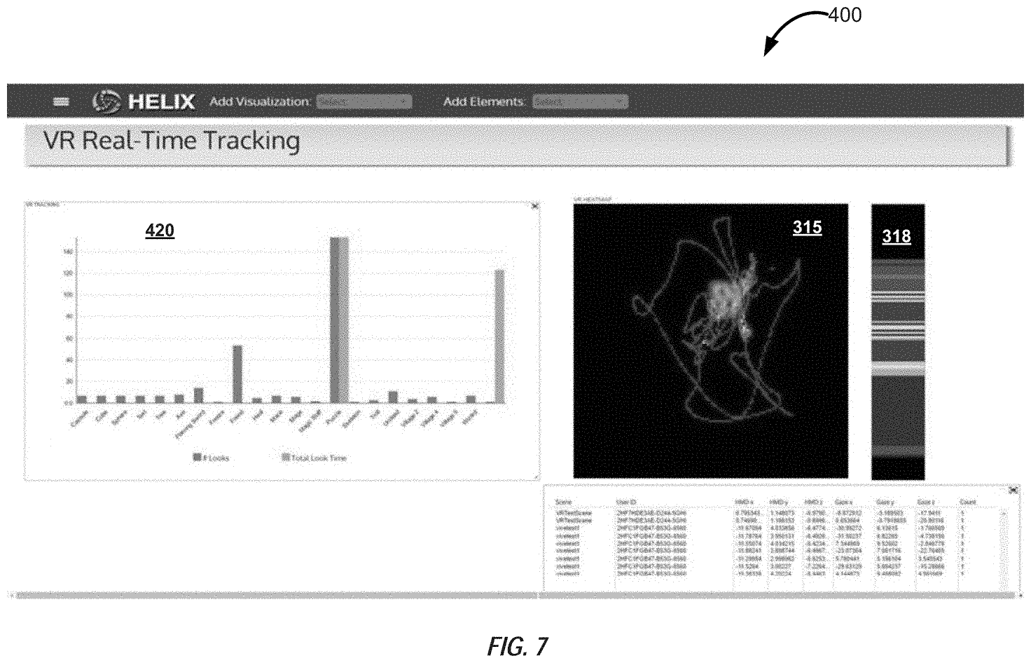

FIG. 6 is a screenshot example of the RTUI module showing the graphical feedback of captured spatial analytics data of the device wearer according to the example embodiments. FIG. 7 is a screenshot example of the analytics front end module showing graphical display outputs from the spatial analytics data. Referring to FIG. 6, there is shown a typical screenshot 300 of analytics information that can be viewed and analyzed by the XR developer. The screenshot 300 is a real time display of a single session running in UNITY. The screen view 310 on the right-hand side includes a capture heat map 315 shown in two dimensions in the x-y plane and a third dimension heap map view 318 in the z-plane. All of this information represents the transformed raw spatial analytical data and communicates to the developer the following things in near real time (essentially mere milliseconds after collection: the 2D heat map 315 shows a top-down view of the wearer's position in their digital reality environment, and the z-dimension heat map 318 shows the wearer's vertical positions above the floor within their digital reality environment. As is known these heat maps 315, 318 reflect the amount of time the wearer spends in any one location or height, using a well-known blue-white-yellow-red color progression from the least amount of time to the most time the wearer spends in any one top-down or vertical position.

The left-hand screen view 320 on the other hand reflects near real time emotional analytical information that has been transformed from collected raw emotional data taken from the wearer in real time as they experience the digital reality space. This is described in greater detail in the co-pending ______ application incorporated by reference herein. The two views 310, 320 in the screenshot 300 of FIG. 6 collectively represent a single session. In an example, each session may be assigned a unique session ID and a corresponding user ID. In this instance, the user can be any of the end user/consumer (operating their own machine such as a SONY PlayStation, PC, MAC, and the like), a developer's machine (PC, MAC, XBOX PS4, etc.) being used by consumer or run by the developer), whether the “user” is the first time participant or already has a user ID with multiple sessions.

Referring to FIG. 7, there is shown a screenshot 400 of recorded data to analyze offline or in non-real time. Screen view 420 is shown in conjunction with the heat maps 315, 318 and represent a session. Although screen view 420 shows a graph of number of looks and look time, other information could be shown, such as a compilation or aggregation of multiple sessions of real time gathering for purposes of for example, performance metrics, wearer play time in application, application utilization, can build timelines for deeper trend analysis, mean usage, outliers, analyzes session time of wearers in the application or on the machine, platform, etc., individually, collectively or selectively from large groups, variation in user trends by location and age or other user demographics as defined by the developer.

In accordance with the above-described example embodiments, the XR developer, in evaluating graphical or display information via the GUI, can review aggregated spatial analytic data of the wearer in near real time to detect outliers. This provides the developer with information enabling them to store, tweak, adjust and/or revise desired product parameters and/or coding in an effort to improve the wearer's experiences within their digital reality environment/virtual world provided by the developer's XR application.

The inventor positions that there is no method, system, or tracking module available in the XR analytics space today that incorporates gathering real time spatial data (x, y, z coordinate data) for analysis and display that includes each of: (a) the wearer's location in both world-space and XR-room-space, (b) the wearer's device orientation, (c) the wearer's view direction (a 3D vector indicating where the user is “looking”), and (d) any objects in the wearer's look path in their digital reality environment. Moreover, the spatial analytic data is gathered in real time for display in near real time (within 10 seconds or less from capture) to the XR developer. These are features and functionality currently unavailable in the XR space today, as no application or platform in digital reality tracks this kind of spatial data on-the-run and then analyzes it in near real time.

The present invention, in its various example embodiments, configurations, and aspects, includes components, methods, processes, systems and/or apparatuses substantially as depicted and described herein, including various embodiments, sub-combinations, and subsets thereof. Those of skill in the art will understand how to make and use the present invention after understanding the present disclosure. The present invention, in its various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The embodiments described herein may be implemented in digital electronic circuitry, or in computer hardware, firmware, software, or in combinations of them. The embodiments can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computer system. A computer program can be deployed to be executed on one computer or on multiple computers at one site or distributed across multiple sites and interconnected by a communication network.

Various aspects of the example embodiments may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

I claim:

1. A computer-implemented method, adapted to track in real time and to analyze in near real time, spatial analytics data of any of a virtual reality (VR), augmented reality (AR) or mixed reality (MR) device attached to a wearer as the wearer operates within their digital reality environment, comprising:
gathering raw spatial analytics data of the wearer in real time as the wearer is experiencing their digital reality environment,
packaging and transforming the real time gathered raw spatial analytics data into intelligible data formats, and
immediately displaying for analysis by a developer of the digital reality environment the transformed spatial analytics data in near real time,
wherein each of the gathering, packaging and transforming, and analyzing and displaying steps are performed by computer software adapted to run on computer hardware.

2. The method of claim 1, wherein gathering further includes collecting x, y, and z coordinate data within the digital reality environment on each of the wearer's:
(i) location therein,
(ii) device orientation therein,
(iii) view direction therein, and
(iv) any objects that are in a look path of the wearer, the gathered x, y, z coordinate data of location, device orientation, view direction, and objects in the wearer's look path collectively representing the spatial analytics data.

3. The method of claim 2, wherein the digital reality environment is an extended reality (XR)-room-space encompassing any of a VR, AR and MR room space created by the developer and to be experienced by the wearer.

4. The method of claim 3, wherein the x, y, and z coordinate data gathered on the wearer's location is collected in both a real world-space and in the XR-room-space.

5. The method of claim 2, wherein the x, y, and z coordinate data gathered on the wearer's view direction is a 3D vector indicating where the wearer is looking.

6. The method of claim 1, wherein the device is any of a headset, eyewear, glasses, and holographic lens worn by or otherwise attached to the wearer, and a mobile platform used by the wearer.

7. The method of claim 1, wherein the digital reality environment is an extended reality (XR)-room-space encompassing any of a VR, AR and MR room space created by the developer and to be experienced by the wearer.

8. The method of claim 1, where near real time is 10 seconds or less after the raw spatial analytics data is gathered in real time.

9. A non-transitory, computer-readable information storage media having stored thereon information, that when executed by a processor causes the steps in claim 1 to be performed.

10. A computer system adapted to track and analyze spatial analytics data of any of a virtual reality (VR), augmented reality (AR) or mixed reality (MR) device wearer as the wearer operates within their digital reality environment, comprising:
a processing hardware set, and
a computer-readable storage device medium, wherein
the processing hardware set is structured, connected and/or programmed to run program instructions stored on the computer-readable storage medium instructions and associated data, the program instructions including:
a tracking module programmed to gather raw spatial analytics data of the wearer in real time as the wearer is experiencing their digital reality environment and to transform the raw data into intelligible data formats,
a database module programmed to receive the transformed spatial analytics data gathered by the tracking module in real time and to package the data for network transmission to a support database for permanent storage, and
a real time user interface module programmed to, upon receiving the transformed real time spatial analytics data of the wearer from the tracking module, immediately enable a developer of the wearer's environment to graphically review and analyze the transformed spatial analytics data in near real time.

11. The system of claim 10, wherein the gathering of raw spatial analytics data by the tracking module includes collecting x, y, and z coordinate data on each of the wearer's location, the wearer's device orientation, the wearer's view direction, and any objects that are in a look path of the wearer, the gathered x, y, z coordinate data collectively representing the raw spatial analytics data of the wearer.

12. The system of claim 10, wherein the real time user interface module programmed to enable the developer to see spatially where the wearer is within their digital reality environment, to see spatially where the wearer spends time or does not spend time within their digital reality environment, and to see spatially which objects the wearer views or interacts within their digital reality environment.

13. The system of claim 10, wherein the tracking module is further adapted to package and transform the raw spatial analytics data into 3D world space coordinate data, and to communicate the coordinate data in near real time to the real time user interface module for display and analysis by the developer and to the database module for storage.

14. The system of claim 10, wherein the digital reality environment is an extended reality (XR)-room-space encompassing any of a VR, AR and MR room space created by the developer and to be experienced by the wearer.

15. The system of claim 10, where near real time is 10 seconds or less after the tracking module gathers the raw spatial analytics data in real time.

16. The system of claim 15, wherein the x, y, and z coordinate data collected by the tracking module on the wearer's location is collected in both a real world-space and in the XR-room-space.

17. The system of claim 11, wherein the x, y, and z coordinate data collected by the tracking module on the wearer's view direction is a 3D vector indicating where the wearer is looking.

18. A computer system having therein a set of machine-readable instructions and associated data, stored on a storage device of the system in a manner more persistent than a signal in transit, the set of instructions and associated data enabling the system to track real time data of any of a virtual reality (VR), augmented reality (AR) or mixed reality (MR) device wearer as the wearer operates in their digital reality environment, so as to generate spatial analytics information of the wearer for display and analysis, the system comprising:
a tracking module programmed in accordance with the set of machine-readable instructions and associated data to gather raw spatial analytics data of the wearer in real time as the wearer operates in their environment, and
a real time user interface module programmed in accordance with the set of machine-readable instructions and associated data to, enable a developer of the system to see graphically in near real time spatially where the wearer is in within the wearer's digital reality environment, to see spatially where the wearer spends time or does not spend time within their digital reality environment, and to see spatially which objects the wearer views or interacts within their digital reality environment.

19. The system of claim 18, wherein
the digital reality environment is an extended reality (XR)-room-space encompassing any of a VR, AR and MR room space created by the developer and to be experienced by the wearer, and
near real time represents 10 seconds or less after the tracking module gathers the raw spatial analytics data in real time.
